(19) United States
(12) Patent Application Publication
(10) Pub. No.: US 2014/0144076 A1
(43) Pub. Date: May 29, 2014

(54) Apparatus and method for an adjustable plant support

(71) Applicant: Robert Deeb, Averill Park, NY (US)

(72) Inventor: Robert Deeb, Averill Park, NY (US)

(21) Appl. No.: 13/684,575

(22) Filed: Nov. 26, 2012

(51) Int. Cl. A01G 9/12

(52) U.S. Cl. CPC A01G 9/122
USPC 47/47; 47/58.1 R

(57) ABSTRACT

This disclosure combines the use of snap connectors embedded in flexible straps that are wrapped around tomato or other vine plants, together with a plant support rod or stake containing reciprocal snap connectors onto which the snap connectors embedded in the flexible straps are to be either secured into place at varying points along the plant support rod or for each flexible strap to be secured onto itself or another flexible strap while wrapped around the vine plant and plant support rod. The purpose of the apparatus is to accommodate plant growth and to maintain a vertical growth path for the vine plant.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND

This invention relates to the support of plants, and in particular vine plants, in their growth from seedling to mature plant. Various support apparatus have been used to support plant material as it grows and bears fruit or vegetables. Many tomato plant growers, and those involved in growing vine plants in general, seek to ensure that these plants grow in a vertical direction in a controlled pattern of growth. Without a vertical support structure the tomato plant and other vine plants will grow as much horizontally as vertically or in several directions simultaneously. This is undesirable if the grower wants to maximize tomato or other vine plant yield, ensure sunlight access or to avoid predation by insects. There are several different support apparatuses that have been patented. They typically involve various mechanisms whose main purpose is to assist the vertical growth of the vine plants. These support structures usually involve metal or other materially constructed rods in a cage type or lattice type or geometrical configuration. These structures are usually rigid to a large degree and entail multiple threading and interweaving of the vine plant through the support mechanism. This can lead to a complicated attachment mechanism between the plant and the support structure which can increase the risk of damage to the vine plant from adjustment by people growing the plants. For these reasons, there is a need for an apparatus that is simple to use, flexible and uncomplicated.

### SUMMARY

This invention relates generally to gardening accessories and more particularly concerns supports for long stemmed plants such as tomato plants and the like.

The invention comprises flexible binding straps onto which are embedded or inserted snap-fit assemblies. These flexible binding straps are wound or wrapped around the plant stem and then snapped onto reciprocating snap-fit assemblies either on an accompanying rod or stake or alternatively onto the snap-fit assembly on the other end of the flexible strap. Snap-fit assemblies are placed at varying points along the length of the rod or stake to allow for adjustment of the support straps at different points along the plant stem. In the alternative, it is possible to use other connecting mechanisms to connect the binding straps together or to another item such as the rod or stake. One alternative would be Velcro strips or the like.

This present apparatus is a simple and effective way to provide support to growing vine plants and the like in order to protect these plants and to maximize their yield potential. One of the objects of this invention is to provide an improved plant support. This invention may also be applicable to any vine type plant where people want to control the path or direction of growth that the plant undertakes. This apparatus aims to eliminate complexity in plant support mechanisms by simplifying the parts used for the support structure and to provide for flexibility in the support apparatus so as to be able to respond to the growing plant. Work in installing and maintaining plant supports will be reduced. The process will take less time, will be easier to use and be straightforward so as to avoid damaging the plants when making height adjustments to the support apparatus.

The apparatus, including rod or stake and flexible straps, can be manufactured from different materials. In addition, the apparatus provides a method for the use of the adjustable support by a user.

### DRAWINGS

These and other features, aspects, and advantages of the present invention will become better understood with regard to the following description, appended claims, and accompanying drawings where:

FIG. 1 shows a partial detailed view of the front and back of the rod or stake and the placement of the snap attachments on the rod or stake.

FIG. 2 shows a close-up view of the top of the rod or stake shown in FIG. 1.

FIG. 3 shows a close-up view of the bottom of the rod or stake shown in FIG. 1.

FIG. 4 is a perspective view which shows the apparatus in use supporting a vine plant.

FIG. 5 is a close-up view of a flexible strap used with the apparatus with snap attachments fitted onto the said flexible straps.

FIG. 6 shows a flexible strap, two of whose snap connectors have been attached to each other at one end of the flexible strap.

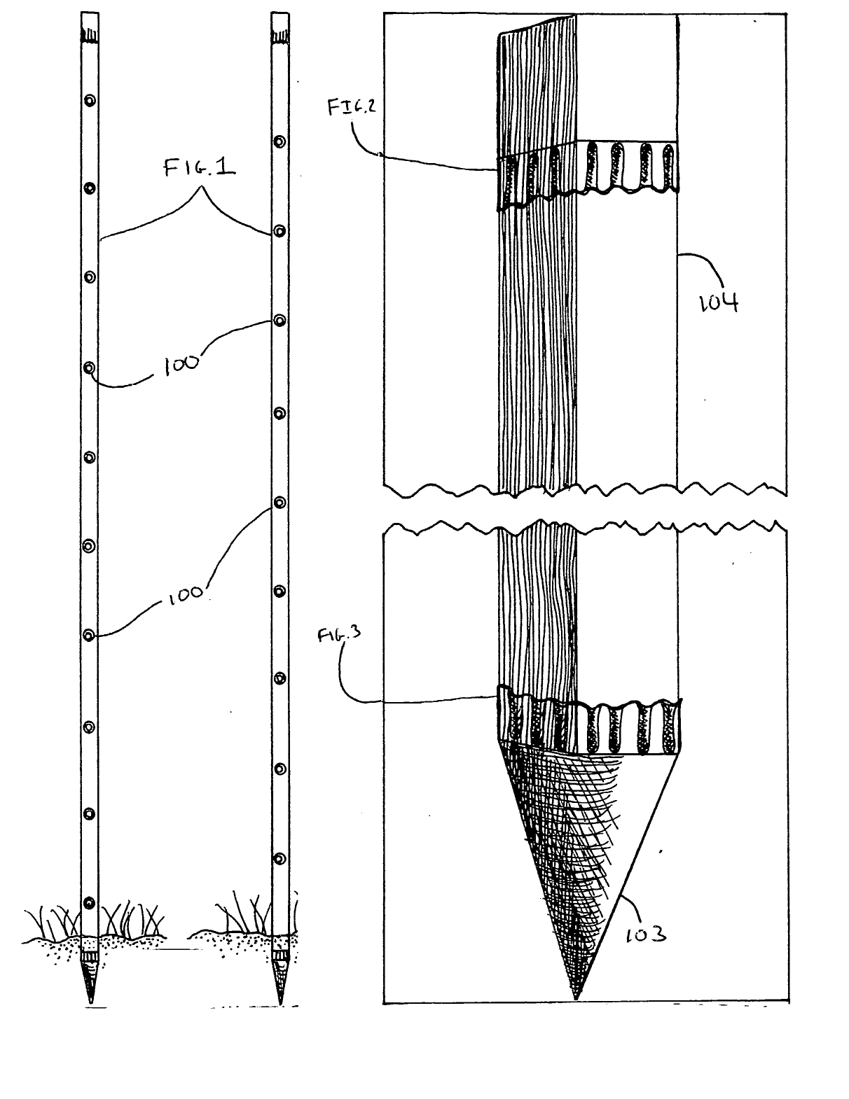

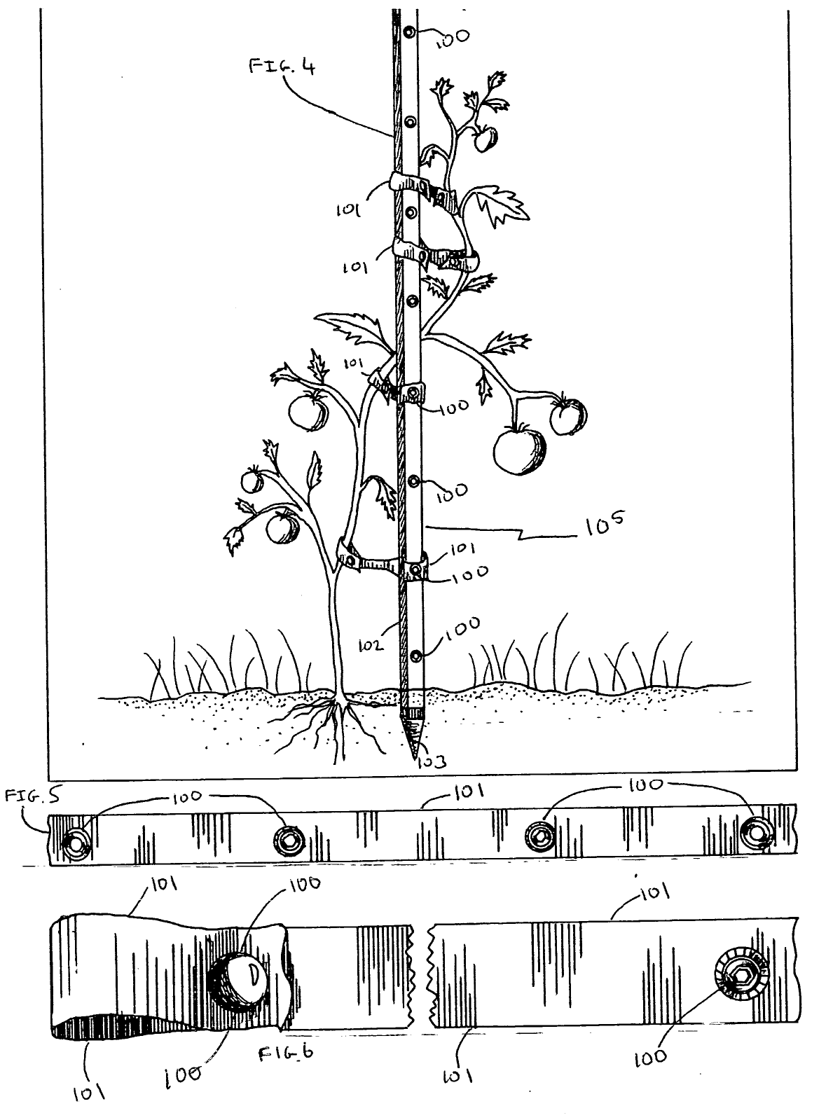

### DESCRIPTION

Referring to the drawings, there is illustrated an adjustable plant support 105 in accordance with the invention providing for universal adjustability.

This is an apparatus 105 that allows a person working with plants, particularly vine plants, to adjust the height of the support structure for the plant to allow for the vertical growth of the plant and to accommodate the limbs and branches of the plant as they grow.

In the preferred embodiment, the apparatus 105 comprises the use of metal, preferably stainless steel, or perhaps plastic snap connectors 100 or other suitable material, attachments or fasteners manufactured to a commercial grade or acceptable quality which are embedded in flexible straps 101 and which said straps 101 are wrapped around tomato plants or other vine plants. The connectors can comprise snap-fit button assemblies 100. The said snap connectors 100 at the ends of the flexible straps 101 are then snapped or secured into place on another snap connector 100 on the plant support rod or stake 102 or alternatively onto the opposing snap connector 100 on the same flexible strap or different flexible strap 101. The snap connectors 100 include those that are commercially available such as snap-fit button assemblies in any of the variations that such snap-fit button assemblies variously take. The connections that may be embedded on the flexible straps 101 or attached to the plant support rod or stake 102 may alternatively take a variant form of attachment mechanism or fastening notch other than snap connectors principally described herein. In the alternative, the connecting mechanism joining the straps together or to the rod or stake or other assembly can be Velcro strips or the like or other commercially available items for fixing together flexible materials. The flexible straps can be made from any fabric or materials that allows for adjustment to the strap.

A plant support rod or stake 102 which can have a four sided square shape in cross section along the longitudinal axis and which square shape is one inch in length on all sides when observed longitudinally is provided containing at least five pairs of equidistantly spaced snap connectors 100 placed on two opposite sides of the plant support rod or stake 102 at fixed stationary positions and onto which the snap connectors 100, which are embedded in the said flexible straps 101, can be affixed or attached and secured into place at the varying points along the plant support rod or stake 102 at the positions at which the snap attachments 100 are placed along the plant support rod or stake 102 to accommodate plant growth and to maintain a vertical growth path for the vine plant. The rod or stake 102 can also be round in cross section or any other convenient shape and can comprise any variation in number of fastening notches or snap connectors.

The said plant support rod or stake 102 can be made out of a hard plastic material or other durable, weather resistant material substitutes. One end of the plant support rod or stake 102 is tapered to a sharp point or tip and is made from or capped with a metal or other durable, hard surfaced rust protected material 103. This tapered point end 103 of the plant support rod or stake is to be placed into the ground to provide a foundation for the plant support rod or stake 102. The opposite end 104 of the plant support rod or stake 102 has a metal cap or cap made from other durable, hard surfaced rust protected material. The length of the plant support rod or stake 102 is typically 72 inches but can vary in length.

In the preferred embodiment, the said flexible straps 101 will have typically four snap connectors 100 embedded in each flexible strap 101. These snap connectors 100 will be equidistantly placed two at each opposite end of each flexible strap 101. This will allow for a choice of length used for each flexible strap 101 when attaching the strap 101 to the snap connectors 100 on the plant support rod or stake 102. Alternatively, there may be more than four snap connectors 100 on the said flexible straps 101. The said flexible straps 101 can be made from any durable, flexible material that will enable the straps 101 to be easily pliable and which can be readily wrapped around the stem of a vine plant or any other plant. Such materials may be plastic or cloth fabric based. for example. The straps 101 can be made into varying overall lengths such as 12 inches, 16 inches or 18 inches so as to allow for adjustment that permits the user of this apparatus 105 to loosely wrap the flexible strap 101 around the plant without causing damage to the plant and permitting also the natural growth of the plant without any other impediment. Each opposite end of the said flexible straps 101 is then attached, fastened or secured into place at the snap connectors 100 on the said plant support rod or stake 102 securing in place the flexible straps 101 onto the chosen fixed points on the plant support rod or stake 102. Alternatively, the flexible straps 101 can be attached, fastened or secured to the same flexible strap or another flexible strap 101.

This structure is just one example of elements operable in the aforesaid apparatus.

Another embodiment of the adjustable plant support apparatus 105 would include the option to snap each end of a strap 101 onto each other around the rod or stake 102 without attaching the strap 101 to the rod or stake 102. This gives the user the option to buy just the straps 101.

In accord with another aspect of the adjustable plant support 105, a method of using the apparatus 105 is also provided.

It is not necessary for all embodiments of the invention to have all the advantages of the invention or fulfill all the purposes of the apparatus.

While the instant apparatus has been shown and described in accordance with preferred and practical embodiments thereof, it is recognized that departures may be made from the instant disclosure. Therefore, the spirit and scope of the appended claims should not be limited to the description of the preferred versions contained herein.

In the Summary above and in the Description, and the Claims below, and in the accompanying drawings, reference is made to particular features (including method steps) of the apparatus. It is to be understood that the disclosure of the apparatus in this specification includes all possible combinations of such particular features. For example, where a particular feature is disclosed in the context of a particular aspect or embodiment of the apparatus, or a particular claim, that feature can also be used, to the extent possible, in combination with and/or in the context of other particular aspects and embodiments of the apparatus, and in the apparatus generally.

The term “comprises” and grammatical equivalents thereof are used herein to mean that other components, ingredients, steps, etc. are optionally present. For example, an article “comprising” (or “which comprises”) components A, B and C can consist of (i.e. contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps, which are carried out before any of the defined steps, between two of the defined steps, or after all the defined steps (except where the context excludes that possibility).

What is claimed is:

1. An adjustable plant support apparatus comprising:
a rod or stake onto which is affixed snap connectors;
straps having snap connectors embedded into the material of each strap;
means for winding or wrapping the said straps around the stems of vine plants or other types of plants and then affixing the snap connectors embedded on the said straps to the snap connectors on either side of the said rod or stake or to the snap connectors on the same strap or another strap,
whereby said vine plant or other type of plant will be supported during it's growth.

2. An adjustable plant support apparatus as defined in claim 1 wherein the snap connectors are made from metal, such as stainless steel, or plastic or other suitable material.

3. An adjustable plant support apparatus as defined in claim 1 wherein the snap connectors are of the snap-fit button assembly type or variants thereof.

4. An adjustable plant support apparatus as defined in claim 1 wherein the rod or stake comprises at least five pairs of equidistantly spaced snap connectors.

5. An adjustable plant support apparatus as defined in claim 1 wherein the rod or stake has a metal tip on the end that is driven into the ground and a metal cap on the opposite end.

6. An adjustable plant support apparatus as defined in claim 1 wherein the rod or stake is four sided and is a square in cross section with a dimension length of one inch on each side.

7. An adjustable plant support apparatus as defined in claim 1 wherein the shaft of the rod or stake is manufactured from plastic, wood or fiber glass.

8. An adjustable plant support apparatus as defined in claim 1 wherein the rod or stake has a longitudinal length of 72 inches.

9. An adjustable plant support apparatus as defined in claim 1 wherein the flexible straps can be of different lengths such as 12 inches, 16 inches or 18 inches or other varying lengths.

10. An adjustable plant support apparatus as defined in claim 1 wherein the straps are made from differing materials such as cloth or plastic or other flexible material.

11. An adjustable plant support apparatus as defined in claim 1 wherein the straps have two commercial grade metal or plastic snap connectors embedded into each opposite end of the strap.

12. An adjustable plant support apparatus as defined in claim 1 wherein the straps have connecting means such as Velcro strip connectors or other commercial means for binding straps together.

13. An adjustable plant support apparatus as defined in claim 1 wherein said straps are wound or wrapped around the stems of vine plants or other plants and then wound or wrapped around the said rod or stake and then each snap connector embedded on each flexible strap is affixed to another snap connector on the same strap or another strap.

14. A method for an adjustable plant support, comprising:
winding or wrapping the said straps around the stems of vine plants or other plants, and then affixing the snap connectors embedded on the said straps to the snap connectors on either the said rod or stake or to the snap connectors on the same strap or another strap,
whereby said vine plant or other type of plant will be supported during its growth.

15. The method as defined in claim 14 wherein the straps have connecting means such as Velcro strip connectors or other commercial means for binding straps together.

16. A method for an adjustable plant support, comprising:
a rod or stake onto which is affixed snap connectors;
straps having snap connectors embedded into the material of each strap;
means for winding or wrapping the said straps around the stems of vine plants or other types of plants and then affixing the snap connectors embedded on the said straps to the snap connectors on either the said rod or stake or to the snap connectors on the same strap or another strap,
whereby said vine plant or other type of plant will be supported during its growth; and
the method comprising:
winding or wrapping the said flexible straps around the stems of vine plants or other plants, and then affixing the snap connectors embedded on the said straps to the snap connectors on either the said rod or stake or to the snap connectors on the same strap or another strap,
whereby said vine plant or other type of plant will be supported during its growth.
